(19) United States
(12) Patent Application Publication
(10) Pub. No.: US 2014/0161468 A1
(43) Pub. Date: Jun. 12, 2014

(54) OPTICAL ISOLATION SYSTEM AND ASSEMBLY

(71) Applicant: GENERAL ELECTRIC COMPANY, Schenectady, NY (US)

(72) Inventors: Jon Wei Chow, Malden, MA (US); Michael Joseph Gambuzza, Pepperell, MA (US); Alexander Charles Brindle, Medford, MA (US)

(73) Assignee: General Electric Company, Schenectady, NY (US)

(21) Appl. No.: 13/708,692

(22) Filed: Dec. 7, 2012

(51) Int. Cl. H04B 10/00

(52) U.S. Cl. CPC H04B 10/802; H04B 10/30
USPC 398/140; 250/551

(57) ABSTRACT

An optical isolation system and assembly includes LEDs and photodiodes separated by an electrical isolation gap. A cover including a plurality of compartments physically encompasses each LED and photodiode pair.

### BACKGROUND OF THE INVENTION

The subject matter disclosed herein relates to an optical data transmission circuit and, in particular, one that is compliant with Intrinsic Safety standards.

Intrinsic Safety (IS) is a protection technique for safe operation of electronic equipment used, for example, in explosive environments. In order to satisfy IS requirements, it is necessary that electric and electronic equipment and circuitry limit the amount of energy, thermal or electrical, introduced into the hazardous environment to render them incapable of causing an explosion. One method that is typically employed utilizes transient suppression techniques such as connecting grounded zener diodes with fuses to all electric supply wires and signal wires. Several exemplary requirements for IS are disclosed in the standards publication International Electrotechnical Commission (IEC) document 60079-11, which is the governing document for operation in explosive environments. It specifies the construction and testing of intrinsically safe apparatuses intended for use in an explosive environments and which are intended for connection to intrinsically safe circuits which enter such environments.

Under IS standards, if a commonly available integrated optical isolator is used in the apparatus, it must be assumed that there will be potential failure of the galvanic isolation inside the apparatus. Therefore, the energy transmitted must be limited by the inclusion of fuses and zener diode barriers, as mentioned above, on the emitter side and the detector side of the circuit. For multiple signal paths and multiple optical isolators, this becomes costly. For IS design, energy used by commonly available integrated optical coupler inputs and outputs needs to be limited to two-thirds of their rating per IEC 60079-11. It is difficult to limit the energy and still maintain a high bandwidth.

The discussion above is merely provided for general background information and is not intended to be used as an aid in determining the scope of the claimed subject matter.

### BRIEF DESCRIPTION OF THE INVENTION

A novel cost effective approach to meeting IS requirements using a novel optical isolation system and assembly is disclosed. Data signals are transferred between IS and non-IS sides of the system using an array of photodiodes and light emitting diodes (LEDs) in a discrete implementation. Embodiments disclosed herein exploit the fact that use of discrete components may obviate the need for fuses, zener barriers, and similar devices on each signal path.

An optical isolation system and assembly includes LEDs and photodiodes separated by an electrical isolation gap. A cover including a plurality of compartments physically encompasses each LED and photodiode pair. An advantage that may be realized in the practice of some disclosed embodiments of the optical isolation system is that, with multiple signal paths using multiple optical couplers, significant cost savings are realized, it eliminates the requirement for energy limiting devices, and allows for high bandwidth and high isolation voltage transmission. Scalability allows for quick modification for future product needs such as greater electrical isolation gaps.

One embodiment comprises an optical isolation assembly having a circuit board with a plurality of light emitting diodes each paired with a photodiode and separated by an electrical isolation gap. A cover having a plurality of compartments is attached to the circuit board and each compartment encompasses one of the light emitting diode/photodiode pairs.

Another embodiment comprises an optical isolation system having data transmission circuits and data receiver circuits electrically isolated from each other by an electrical isolation gap. The data receiver circuits can each receive data from one of the data transmission circuits using one of a plurality of optical couplers. Each of the optical couplers is electrically connected to a data transmission circuit using a discrete light emitting diode and to a data receiver circuit using a discrete photodiode. The light emitting diodes optically transmit the data to the photodiodes across the electrical isolation gap. A cover having a plurality of compartments physically surrounds each of the optical couplers.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic diagram of an optical isolation system;

FIG. 2 is a top view of exemplary optical couplers;

FIG. 3 is a side cross-section view of an optical coupler assembly using the optical couplers of FIG. 2;

FIG. 4 is a bottom view of a cover for the optical couplers of FIG. 2; and

FIG. 5 is a side cross-section view of the cover of FIG. 5.

### DETAILED DESCRIPTION OF THE INVENTION

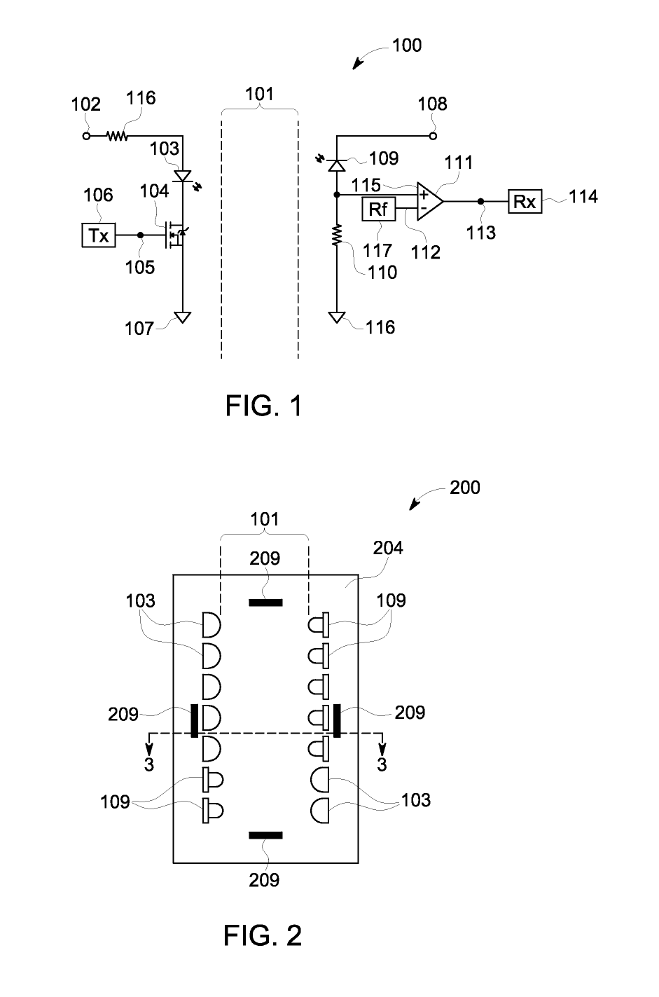

FIG. 1 illustrates an optical isolation system 100 used for transmitting data from a data transmission circuit 106 to a data receiver circuit 114 over an electrical isolation gap 101. The optical isolation system 100 comprises a light emitting diode (LED) 103 connected to a voltage source 102 through a resistor 116 and to a drain terminal of the n type metal oxide semiconductor field effect transistor (n-MOSFET) 104, whose source terminal is connected to transmitter return 107. The gate terminal 105 of n-MOSFET 104 is connected to the data transmission circuit 106. The data signals transmitted from data transmission circuit 106 and received at the n-MOSFET gate terminal 105 modulates current flowing from voltage source 102 through LED 103, thereby generating corresponding optical signals emitted from LED 103, which travel across electrical isolation gap 101 and are detected by photodiode 109.

The optical isolation system 100 further comprises the photodiode 109 connected to a voltage source 108, to a resistor 110 which is connected to receiver return 116, and to one input 115 of a comparator 111. The other input 112 of the comparator 111 is connected to a reference voltage source 117. The output of the comparator is connected to the data receiver circuit 114.

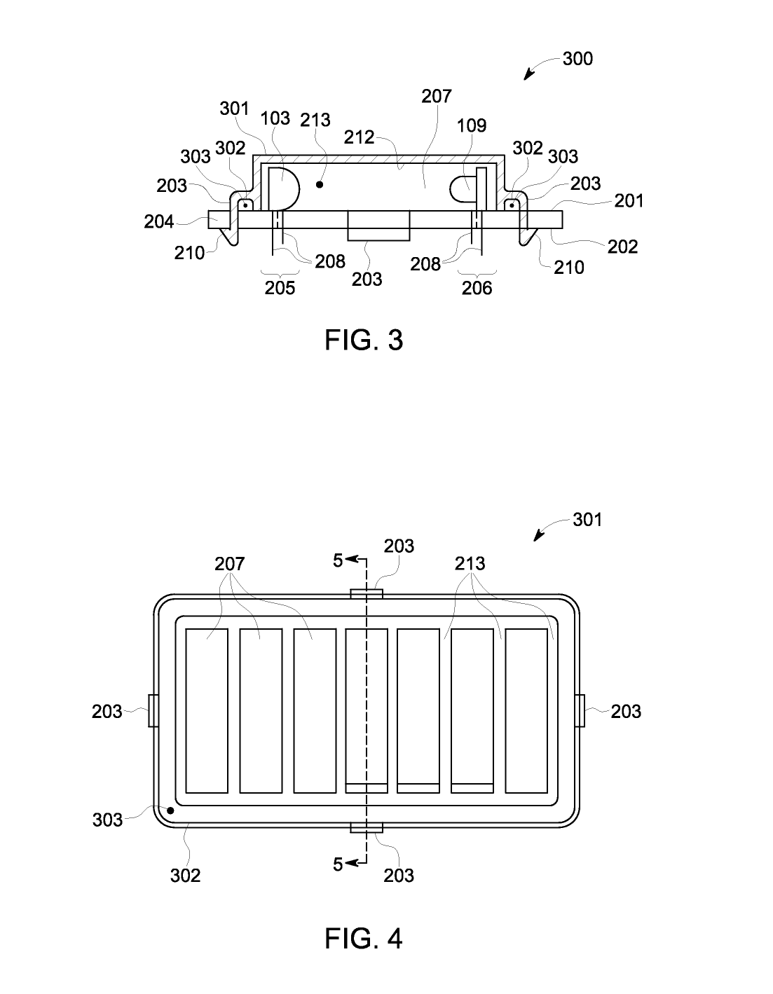

In response to receiving the modulated optical signals from LED 103, the photodiode 109 modulates current flowing from voltage source 108 through resistor 110, thereby generating corresponding electrical input signals at comparator 111 input 115 which results in data transmitted at output 113 of comparator 111 being received at data receiver circuit 114, which is connected to comparator 111. The LED 103 and photodiode 109 together form an optical coupler. Thus, the data transmitted by data transmission circuit 106 is converted to optical signals by LED 103 which are received by photodiode 109 and converted to electrical signals transmitted to data receiver circuit 114 without an electrical path across electrical isolation gap 101. The optical isolation system 100 electrically isolates the electrical components connected to data transmission circuit 106 from the electrical components connected to data receiver circuit 114. Typically, the data transmission circuit 106 is situated in the IS environment (explosive environment), such as sensors within the IS environment, and transmits data to the optical coupler assembly 300 (FIG. 3) that is located outside of the IS environment. Thus, the electrical components on the receiver side of the electrical isolation gap 101 are located in the non-IS environment (non-explosive). Although the optical isolation system illustrated in FIG. 1 shows only one data transmission circuit 106 connected to gate terminal 105 and only one data receiver circuit 114 connected to comparator output 113, additional data transmission circuits 106 and data receiver circuits 114 may be connected thereto, and so this illustrative configuration should not be understood to limit the embodiments described herein.

FIG. 2 illustrates a plurality of optical couplers 200 that may each be used in the optical isolation system of FIG. 1, described above. Hence, the optical couplers 200 support data transmission from multiple data transmission circuits to multiple data receiver circuits. Optical couplers 200 comprise a plurality of LEDs 103 and photodiodes 109 attached to circuit board 204 and separated by an electrical isolation gap 101. As illustrated, electrical isolation gap 101 measures approximately 11 mm, however, various other separation distances may be implemented due to the inherent scalable design of the optical couplers.

FIG. 3 illustrates a side cross-section view 3-3 of the optical couplers 200 having a cover 301 placed thereon to form optical coupler assembly 300. With reference to FIGS. 1-3, the LEDs 103 and photodiodes 109 are disposed on a first surface (top) 201 of a printed circuit board 204. The LEDs 103 and photodiodes 109 are arranged in a linear array on each side of the electrical isolation gap 101, with each LED 103 paired with one corresponding photodiode 109 directly opposite and across the electrical isolation gap 101 as illustrated in FIGS. 2-3. Each LED 103 is aimed to emit light directly toward a corresponding one of the photodiodes 109. Each photodiode 109 is aimed to receive light emitted from its corresponding paired LED 103. Each optical coupler comprises a unidirectional transmission path from the LED 103 to the photodiode 109 of the pair. Two optical couplers are required for bidirectional data transmission across the electrical isolation gap 101. Although FIG. 2 illustrates five photodiodes 109 and two LEDs 103 in the linear array on the left side of the circuit board 204, any number and combination of LEDs 103 and photodiodes 109 may be arranged thereon.

Each LED 103 and each photodiode 109 comprises two electrical terminals having terminal wires 205, 206 connected thereto, respectively. The terminal wires 205, 206 are connected to electric circuits in the circuit board 204 which may be located within a layered circuit board, on its first side 201, its second side 202, or a combination thereof. The terminal wires 205 of LED 103 are connected to the resistor 116 and n-MOSFET 104, as described above with reference to FIG. 1. The resistor 116 and n-MOSFET 104 may also be disposed on the circuit board 204 with the LED 103 or may be disposed elsewhere and electrically connected to the LED terminal wires 205. The terminal wires 206 of photodiode 109 are connected to the voltage source 108, resistor 110, and comparator input 115, as described above with reference to FIG. 1. The voltage source 108, resistor 110, and comparator 111 may also be disposed on the circuit board 204 with the photodiode 109 or may be disposed elsewhere and electrically connected to the photodiode terminal wires 206. As shown in FIG. 3, the terminal wires 205, 206 may extend through circuit board 204 and may be connected to electrical lines disposed on the first side 201 or the second side 202 of circuit board 204, or neither, or both. If not connected to electrical lines on circuit board 204, the terminal wires 205, 206 may be connected to another circuit board disposed adjacent to circuit board 204 or otherwise separately electrically contacted such as by wires, for example.

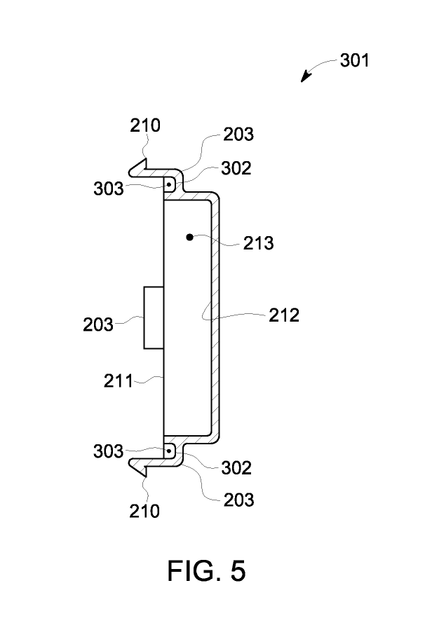

The optical coupler assembly 300 comprises a rectangular cover 301 disposed over the paired LEDs 103 and photodiodes 109. Details of cover 301 are also illustrated in FIGS. 4-5 and are now described in conjunction with FIGS. 2-5. As shown, cover 301 comprises seven compartments 207, each acting as a waveguide, one for each of the seven pairs of LEDs 103 and photodiodes 109, although the number of compartments 207 can be any number and the shape of the cover 301 may assume many forms. Cover 301 may be fabricated by common injection molding techniques using a non-transparent thermoplastic such as an acrylonitrile butadiene styrene (ABS) plastic, polycarbonate, polyetherimide, polyimide, polypropylene, polyethylene, or the like, or combinations thereof. Cover 301 further comprises flexible tabs 203 that mate with corresponding circuit board slots 209. The flexible tabs 203 each comprise a cover latch edge 210 which, when the cover 301 is pressed onto circuit board 204 with the flexible tabs 203 aligned to circuit board slots 209, flexibly deflect inwardly as they are inserted through a corresponding circuit board slot 209. The circuit board slots 209 act as latch catches whereby cover latch edge 210 deflects outwardly back into its original position after insertion and contacts the bottom surface 202 of circuit board 204, thereby securing cover 301 onto circuit board 204.

Although FIGS. 2-5 illustrate flexible tabs 203 on all four sides of rectangular cover 301, such flexible tabs 203 can be formed on less than four sides of cover 301 to mate with corresponding circuit board slots 209. Although the attachment mechanisms are described herein as flexible tabs 203 and slots 209, other means of attaching the cover 301 over optical couplers 200 are considered to be encompassed by the claims below. Such other means may include various mechanical means not requiring slots in the circuit board, such as attachment posts formed on the circuit board, screws, adhesives, press fittings, and the like. Such mechanical means for attachment allows easy removal of the cover 301 for visual inspection of the optical couplers therein.

Cover 301 also includes compartment walls 213 extending between each LED 103 and photodiode 109 pair. The compartment walls 213 are integrally formed with cover 301 and extend from a compartment ceiling 212 to the top surface 201 of circuit board 204 when the cover 301 is attached, e.g., latched, thereto. A compartment wall bottom edge 211 contacts the top surface 201 of circuit board 204 when the cover 301 is attached thereto. Hence, each optical coupler comprising one LED 103 and one photodiode 109 is completely enclosed in a compartment 207 of cover 301, which facilitates the waveguide function provided by the compartments 207, such as the compartment walls 213 acting to prevent crosstalk, e.g., blocking light emitted by an LED 103 from impacting a neighboring photodiode 109. In one embodiment, the cover 301 is made from a plastic comprising white pigment. White compartment walls 213 are more reflective of light emitted from LEDs 103 than compartment walls 213 made from a darker colored plastic. A non-transparent white ABS based plastic cover provides a comparative tracking index (CTI) of equal to or greater than 175 as required by the IEC standards document 60079-11, mentioned above.

Cover 301 also includes a cover perimeter recess 302. Within cover perimeter recess 302 may be disposed a dust seal 303 that contacts top surface 201 of circuit board 204 when the cover 301 is inserted into circuit board slots 209. Such a dust seal 303 may be comprised of a material such as rubber, which may resemble an O-ring in some respects, to prevent dust and debris from entering compartments 207 when the cover 301 is inserted into circuit board slots 209.

In view of the foregoing, embodiments of the invention provide an inexpensive, effective, and scalable optical isolation assembly for communication systems. A technical effect is to eliminate transient suppression devices such as fuses and zener diodes on each of the data transmission lines.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An optical isolation assembly comprising:
a circuit board comprising a first side and a second side;
a plurality of optical couplers each comprising a light emitting diode and a photodiode separated by an electrical isolation gap, the light emitting diodes and photodiodes each individually disposed on the first side of the circuit board; and
a cover comprising a plurality of compartments, the cover attached to the first side of the circuit board and each of the compartments physically encompassing only one of the optical couplers.

2. The assembly of claim 1, wherein the gap comprises a separation distance of about 11 mm.

3. The assembly of claim 1, wherein the cover comprises a dust seal around its perimeter, and wherein the dust seal is in contact with both the cover and the first side of the circuit board.

4. The assembly of claim 1, wherein each of the light emitting diodes and each of the photodiodes comprise a pair of electric terminals that are electrically connected to electrical circuits on the circuit board.

5. The assembly of claim 4, wherein each of the light emitting diodes are connected to a different data transmission circuit.

6. The assembly of claim 5, wherein each of the photodiodes are connected to a different data receiver circuit.

7. The assembly of claim 4, wherein at least one of the light emitting diodes is connected to two different data transmission circuits.

8. The assembly of claim 1, wherein the cover comprises a plurality of flexible tabs corresponding to slots in the circuit board, and wherein the cover attaches to the circuit board by inserting the flexible tabs through the slots in the circuit board.

9. The assembly of claim 1, wherein the compartments comprise compartment walls reflective of the light emitted by the light emitting diodes.

10. The assembly of claim 9, wherein the compartments comprise substantially white compartment walls.

11. The assembly of claim 1, wherein each of the light emitting diodes is electrically connected to a first voltage terminal and to a different field effect transistor for modulating the light emitting diode, and wherein the gates of the field effect transistors are each electrically connected to a different data transmission circuit.

12. The assembly of claim 11, wherein each of the photodiodes is electrically connected to a second voltage terminal, an input of a different comparator, and to a different resistor, and wherein outputs of the comparators are each connected to a different data receiver circuit.

13. An optical isolation system comprising:
data transmission circuits for transmitting data;
data receiver circuits electrically isolated from the data transmission circuits each for receiving the data from one of the data transmission circuits over one of a plurality of optical couplers;
a cover comprising a plurality of compartments each for physically surrounding one of the optical couplers; and
wherein each of the optical couplers is electrically connected to at least one of the data transmission circuits and to at least one of the data receiver circuits, the optical couplers each comprise an electrical isolation gap for optically transmitting the data across the electrical isolation gap, the optical couplers each comprise a discrete light emitting diode electrically connected to one of the data transmission circuits and a discrete photodiode electrically connected to one of the data receiver circuits, and wherein each of the light emitting diodes is optically coupled to one of the photodiodes across the electrical isolation gap.

14. The system of claim 13, wherein each of the light emitting diodes is electrically connected to a voltage terminal and to a different field effect transistor for modulating the light emitting diode, and wherein a gate of the field effect transistor is electrically connected to one of the data transmission circuits.

15. The system of claim 14, wherein each of the photodiodes is electrically connected to a voltage terminal, an input of a different comparator, and to a different resistor, and wherein an output of the comparator is electrically connected to one of the data receiver circuits.

16. The system of claim 13, wherein the optical couplers are disposed on a circuit board and the cover is attached to the circuit board over the optical couplers.

17. The system of claim 16, wherein the circuit board comprises a plurality of slots, the cover comprises a plurality of flexible tabs corresponding to the slots in the circuit board, and wherein the cover attaches to the circuit board by inserting the flexible tabs through the slots in the circuit board.

18. The system of claim 13, wherein the gap comprises a separation distance of about 11 mm.

19. The system of claim 13, wherein the cover comprises a substantially white color.

20. The system of claim 16, wherein the cover comprises a dust seal around its perimeter, and wherein the dust seal is in contact with both the cover and the circuit board.
